(19) United States
(12) Patent Application Publication
(10) Pub. No.: US 2011/0210005 A1
(43) Pub. Date: Sep. 1, 2011

(54) DEVICE SUITABLE FOR THE ELECTROCHEMICAL PROCESSING OF AN OBJECT AND A METHOD THEREFOR

(75) Inventors: Bart Juul Wilhelmina Van Den Bossche, Heis Op Den Berg (BE); Gert Arnold Antoon Nelissen, Overijse (BE); Johan Maria Deconinck, Loonbeek (BE); Hubertus Martinus Maria Cuppens, Leende (NL)

(73) Assignee: ELSYCA N.V., Wijgmaal (BE)

(21) Appl. No.: 13/119,521

(22) PCT Filed: Aug. 17, 2009
(86) PCT No.: PCT/IB2009/006942

§ 371 Date: Apr. 29, 2011

(30) Foreign Application Priority Data
Sep. 19, 2008 (NL) 1035961

(51) Int. Cl. C25D 21/12; C25D 17/00; C25F 7/00; C25D 5/02; C25F 3/00; B23H 3/00; B23H 3/02

(52) U.S. Cl. 205/82; 204/229.4; 204/224 R; 204/223; 204/297.01; 205/96; 205/646; 205/81; 205/645; 205/642; 204/229.2

(57) ABSTRACT

Device and method suitable for the electrochemical processing of an object. The device is provided at least with a chamber for accommodating an electrolyte, means for supporting the object to be processed in this chamber, electrodes arranged in this chamber, and control means for applying an electric current between the object to be processed and the electrodes.

The invention relates to a device suitable for the electrochemical processing of an object, which device is at least provided with a chamber that is to accommodate an electrolyte, means for supporting the object that is to be processed in said chamber, electrodes located in said chamber and arranged in an iterative raster pattern such that during operation at least one electrode is located opposite each portion of a surface of said object that is to be processed, as well as control means for providing an electric current between the object that is to be processed and the electrodes.

The invention also relates to a method suitable for the electrochemical processing of an object, whereby an object is introduced into a chamber containing an electrolyte, whereby an electric current caused to flow between the object to be processed and electrodes by control means, which electrodes are located in said chamber and are arranged in an iterative raster pattern such that during operation at least one electrode is located opposite each portion of a surface of said object that is to be processed.

In such a device, which is known from US 2006/0070887 A1, individual electrodes are consecutively provided with a desired voltage by means of a voltage source.

Electrochemical reactions take place as a result of the voltage between the object and the electrodes.

It is a disadvantage of the known device, however, that an accurate processing of surfaces having a comparatively fine surface structure such as, for example, wafers or printed circuit boards, is substantially not possible, said surfaces being provided with a comparatively thin electrically conducting layer, for example at the start of the electrochemical processing operation, or with an electrically conducting layer that is distributed over the surface in an irregular manner.

The invention has for its object to provide a device with which it is possible in a simple manner to process different objects accurately, while in addition the processing of a specific object can be optimized in a comparatively simple manner.

This object is achieved in the device according to the invention in that the device is provided with a separate current source for each electrode or group of electrodes, such that the electric currents originating from the separate current sources can be supplied by the control means to at least a number of electrodes or a number of groups of electrodes separately and in accordance with predetermined current profiles in time during the electrochemical processing of the object so as to realize a predetermined desired current density distribution across the object.

Since the electrodes or groups of electrodes can be controlled separately, it is possible to generate a current between each electrode or group of electrodes and the object to be processed in a simple manner by means of the separate current sources, which current can be varied during the electrochemical processing of the object in accordance with current profiles determined prior to the electrochemical processing. A certain current density distribution across the object is obtained by means of the current profiles.

The current flowing through a certain position on the object is the determining factor for the electrochemical effect occurring in that position. The processing speed, i.e. the speed at which material is locally applied or removed, bears a simple relationship to the local current density distribution. The prior determination of the desired current density distribution during the electrochemical processing and of the accompanying current profiles renders it possible to control the positions and the quantities of applied or removed material in order to realize desired, comparatively fine surface structures in an accurate manner.

The arrangement of the electrodes in an iterative raster pattern renders it possible in a simple manner to realize any desired local electric current density in any desired location at any moment during the electrochemical processing operation of the object.

An ‘iterative raster pattern’ herein is understood to denote an arrangement of electrodes in which the electrodes are located at least in a plane that is substantially parallel to the surface to be processed, which plane is subdivided into segments along both its main axes such that at least one electrode is located in substantially each segment.

It is furthermore possible here to use a certain selection from the available electrodes for processing one object while in processing a next object a different selection from the electrodes is energized, which renders the device suitable for the processing of different objects in a simple manner.

It is further noted that international patent application WO 2008/010090 A2 of the present applicant disclosing a device and a method provides a holder fitted with a number of rod-shaped counter electrodes and a number of rod-shaped coelectrodes, also denoted ‘current robbers’ therein. The number of electrodes and the positions of the electrodes in the holder are determined in dependence on the object to be processed.

This known device renders it possible, in particular through the use of the coelectrodes, to obtain an even potential distribution over the entire surface of the object to be processed, so that a comparatively high processing accuracy with a reasonably uniform layer thickness can be realized by the currents occurring during this.

A disadvantage of this known device is, however, that the holder is to be provided with a different number of counter electrodes and coelectrodes, which are provided in the holder in a different pattern of a different configuration, for the processing of an object of a different nature. Making the device suitable for processing an object of a different nature is comparatively time-consuming as a result of this.

An embodiment of the device according to the invention is characterised in that the device is provided with contact means for electrically contacting the object, and electrodes located close to contact means are provided with a current profile different from that of electrodes located at a distance from the contact means by the control means during the electrochemical processing operation.

During processing of an object wherein initially only a comparatively thin electrically conductive layer is present on the object, a greater electrical potential difference will arise relative to the counter electrodes adjacent the contact means than relative to electrodes at a distance from the contact means, so that also, for example, a layer to be formed on the object will be thicker adjacent the contact means than at a distance from the contact means. By means of the device according to the invention first a layer on the object opposite to electrodes located close to the contact means is provided, so that this layer is given a better conductivity. The electrodes located at a distance from the contact means are subsequently switched on so that a layer can also be provided on the object opposite these electrodes. To prevent the layer on the object adjacent the contact means from becoming too thick, the electrodes located adjacent the contact means must be cut off from the current earlier than the electrodes located at a distance from the contact means. When the electrodes are controlled in this manner, an even layer thickness is obtained on the object. Alternative current profiles are conceivable wherein the amplitude, polarity, duration, frequency, etc. of the electric current is determined in dependence on the position of the electrode relative to the contact means.

Another embodiment of the device according to the invention is characterised in that the object and the electrodes are displaceable relative to one another, and the control means are capable of applying the electric current through the electrodes in dependence on the position of the electrodes relative to the object.

In processing an elongate object of which only a portion is located opposite the electrodes, it is possible to displace the object along the electrodes, for example at a constant speed. The electrodes are controlled during this such that the desired local electrical current density distribution obtains between the relevant electrodes and a certain location on the object.

It is alternatively possible to have the object and the electrodes perform a reciprocal displacement relative to one another, or a rotary displacement, wherein electrodes are substantially constantly present opposite the object. The mutual displacement here provides a good circulation of fresh electrolyte. An adaptation of the electric current between a respective electrode and the location on the object instantaneously present opposite this electrode renders it possible to realize a desired electrical current density distribution at any moment and on every location on the object.

Yet another embodiment of the device according to the invention is characterised in that the electrodes are arranged in the iterative raster pattern in a holder.

Since the electrodes are arranged in the iterative raster pattern with a raster of, for example, 4×4 mm, the device is suitable for processing a wide variety of objects of different kinds, wherein all or only a portion of the electrodes will be utilized in dependence on the respective object.

A further embodiment of the device according to the invention is characterised in that the holder comprises at least a printed circuit board for controlling the individual electrodes.

The holder thus acts as a support for the electrodes and as a provider of current to the individual electrodes.

A further embodiment of the device according to the invention is characterised in that the control means comprise said holder and a control unit located at a distance from the holder.

The control unit may comprise, for example, a processor, a digital to analog converter, and amplifiers.

The fact that the control unit is at a distance from the holder means that during operation it is only the holder that is inside the electrolyte, so that only the holder needs to be protected against the possible chemical influence of the electrolyte. It is furthermore possible here to replace the holder with another holder in the case of damage or maintenance while continuing to use the same control unit. Such a holder also has a simpler construction than a holder into which the control unit has been integrated. The control unit may be provided with instructions, for example from a PC.

Another embodiment of the device according to the invention is characterised in that an electrode acts as a counter electrode or as a coelectrode in dependence on the direction of the current flowing between the electrode and the object and generated by the control means.

The control means are capable of adapting the polarity of an electrode relative to the object in a simple manner, so that the electrodes can act either as counter electrodes or as coelectrodes. It is also possible to have an electrode act first as a counter electrode and subsequently as a coelectrode or vice versa during the processing of an object in dependence on the desired local electrical current density on the object.

Yet another embodiment of the device according to the invention is characterised in that a comparatively weak current can be passed by the control means through those electrodes that are substantially not required for the electrochemical process.

To prevent a layer similar to the one formed on the object from being formed on electrodes not required for the electrochemical process, it is possible to cause a comparatively weak anodic current to flow through these electrodes, so that a deposition of a layer on these electrodes is prevented in a simple manner. This comparatively weak current is preferably such that it substantially does not influence the electrochemical processing of the object.

Another embodiment of the device according to the invention is characterised in that the device is provided with checking means for applying a potential difference between each electrode in turn and a reference object and for measuring the current arising therefrom, which current can be compared by the checking means with an expected current, such that the relevant electrode is to be replaced or repaired in the case of a comparatively great difference.

It is alternatively possible to apply a current and to check whether an accompanying expected potential difference arises.

It can thus be ascertained in a comparatively simple manner whether an electrode is damaged or is no longer sufficiently provided with an electrode covering layer. The layer is, for example, an activating layer such as a platinum or iridium oxide layer. Such an electrode will not function optimally in the electrochemical processing of the object and should accordingly be cleaned, repaired, or replaced.

A yet further embodiment of the device according to the invention is characterised in that the electrodes are rod-shaped.

It is possible for ends of the rod-shaped electrodes to lie comparatively close to the object to be processed, which offers a satisfactory management of the current density distribution over the object, while at the same time electrolyte can flow through the space between the rod-shaped electrodes, whereby a good renewal of the electrolyte is safeguarded. Electrodes mutually separated by electrolyte provide a possibility of realizing an accurate desired current density distribution even if the number of electrodes is comparatively limited. If the number of electrodes is limited, a limited number of current sources and comparatively simple control means can suffice.

The invention will now be explained in more detail with reference to the drawing, in which:

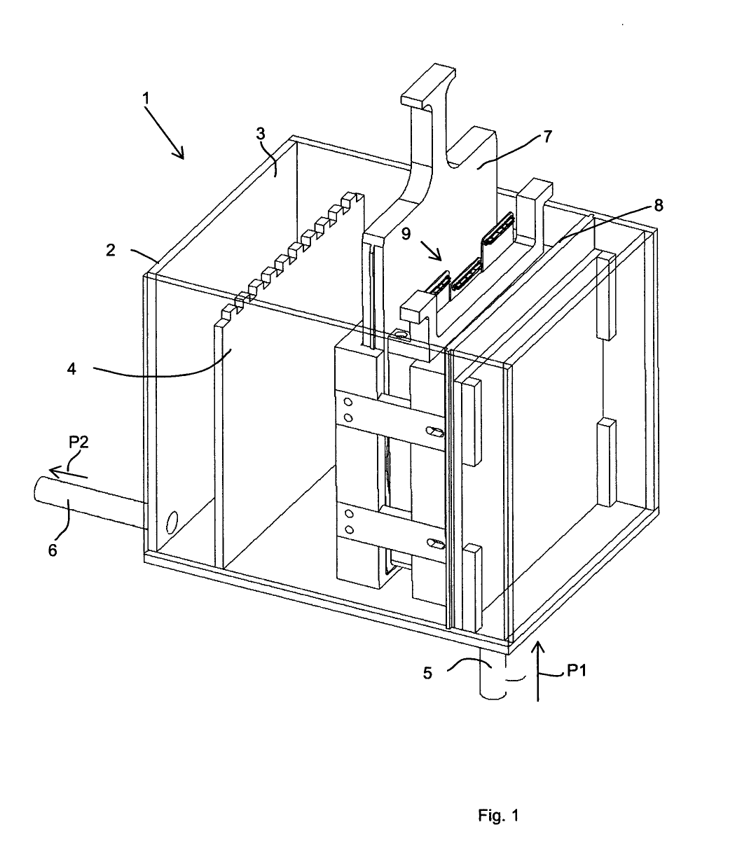

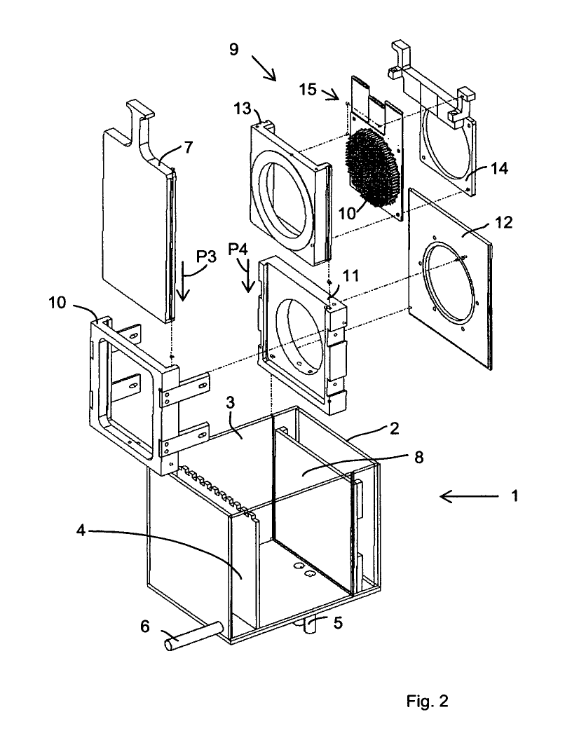

FIG. 1 is a perspective view of a device according to the invention,

FIG. 2 is an exploded view of the device shown in FIG. 1,

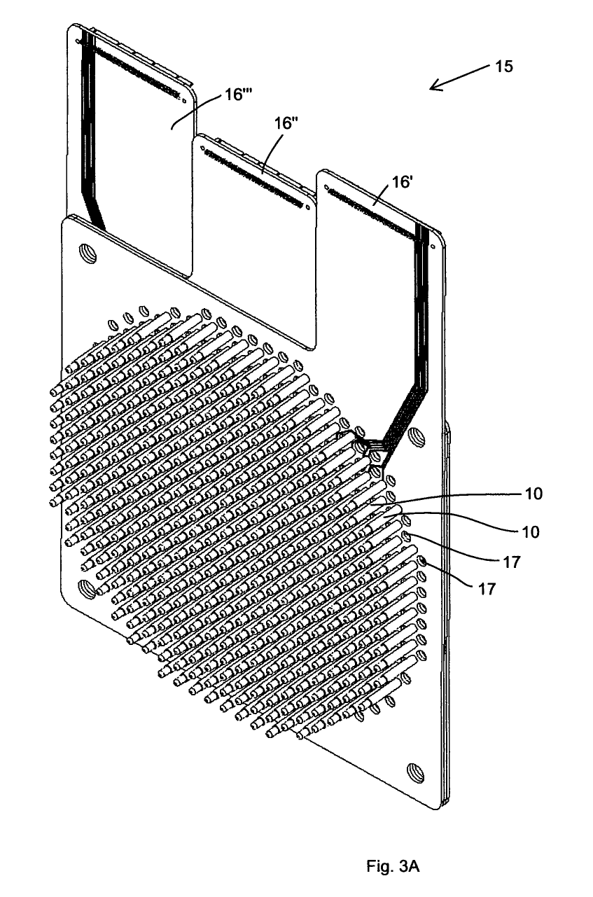

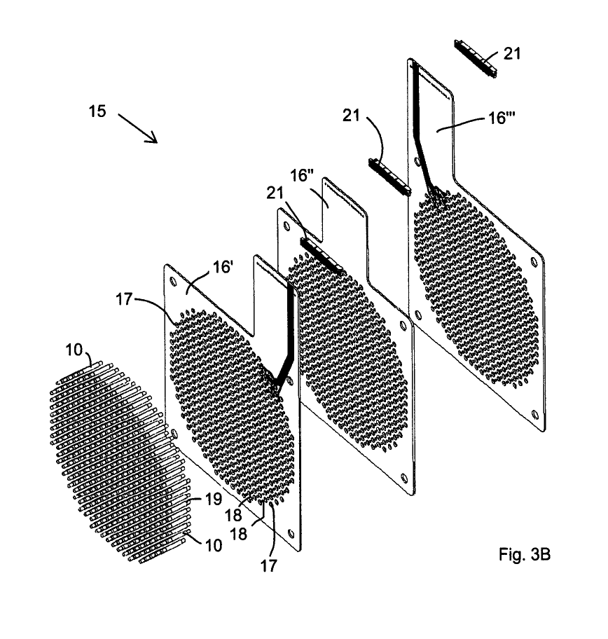

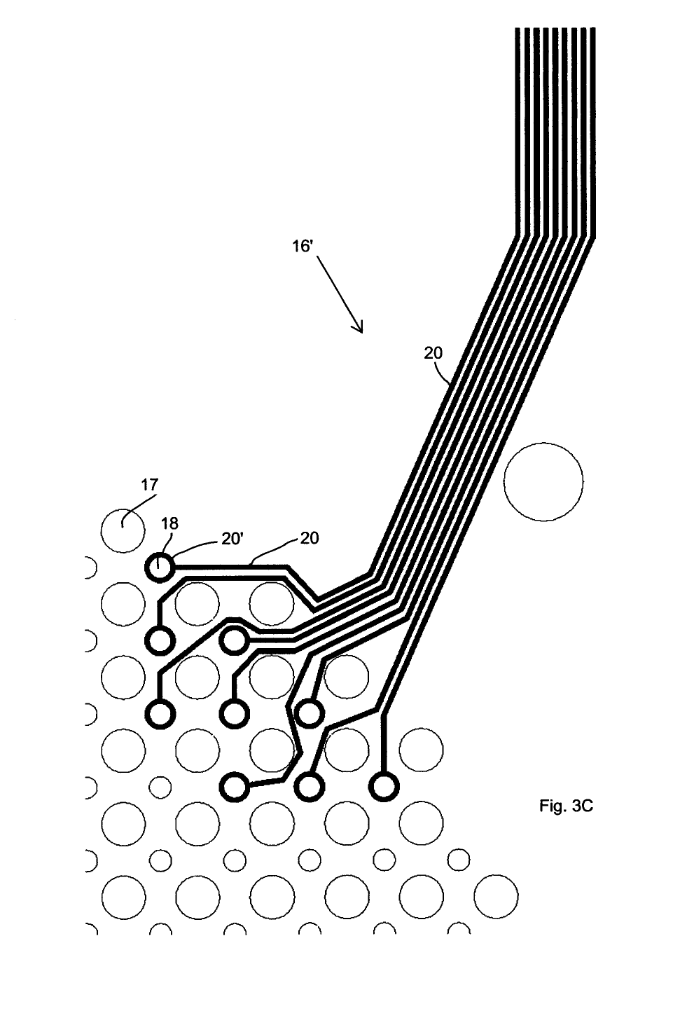

FIGS. 3A to 3C are a perspective view, an exploded perspective view, and a detail of a holder with electrodes of the device shown in FIG. 1,

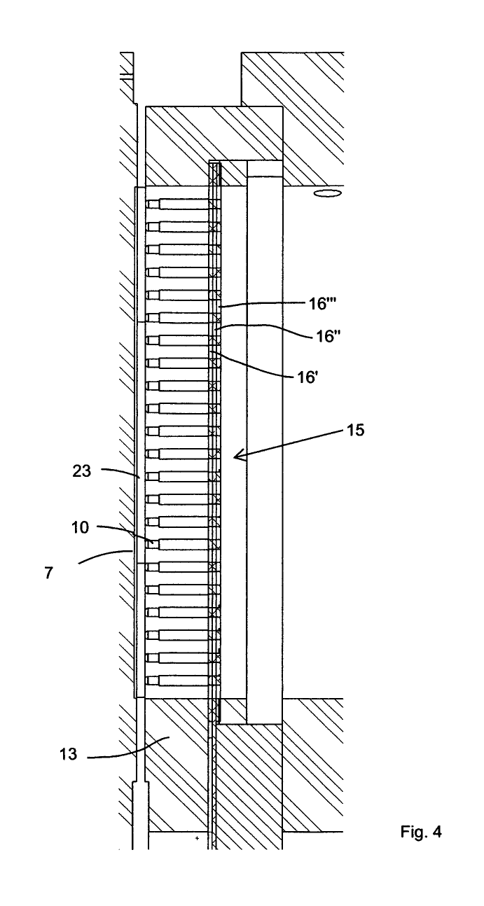

FIG. 4 shows a cross-section through a portion of the device shown in FIG. 1,

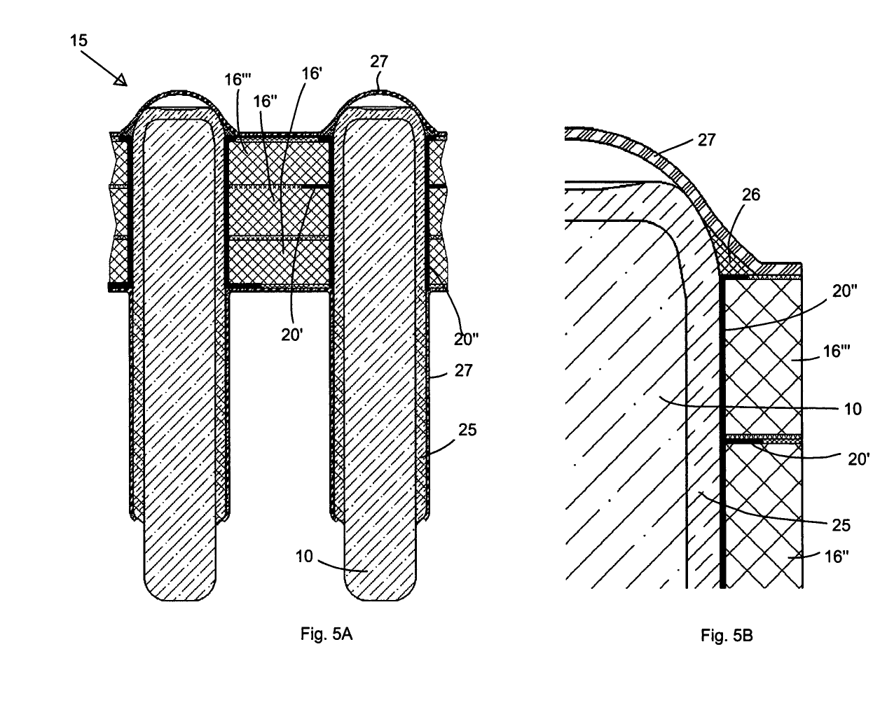

FIGS. 5A and 5B show a cross-section and an enlarged detail of a first embodiment of a holder with electrodes of the device shown in FIG. 1,

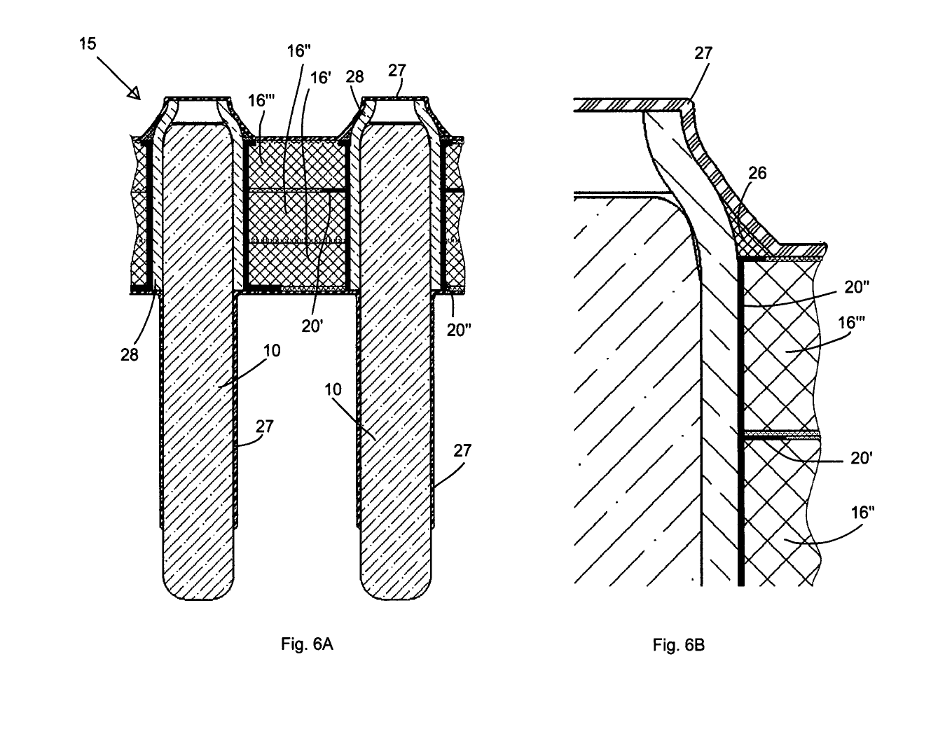

FIGS. 6A and 6B show a cross-section and an enlarged detail of a second embodiment of a holder with electrodes of the device shown in FIG. 1,

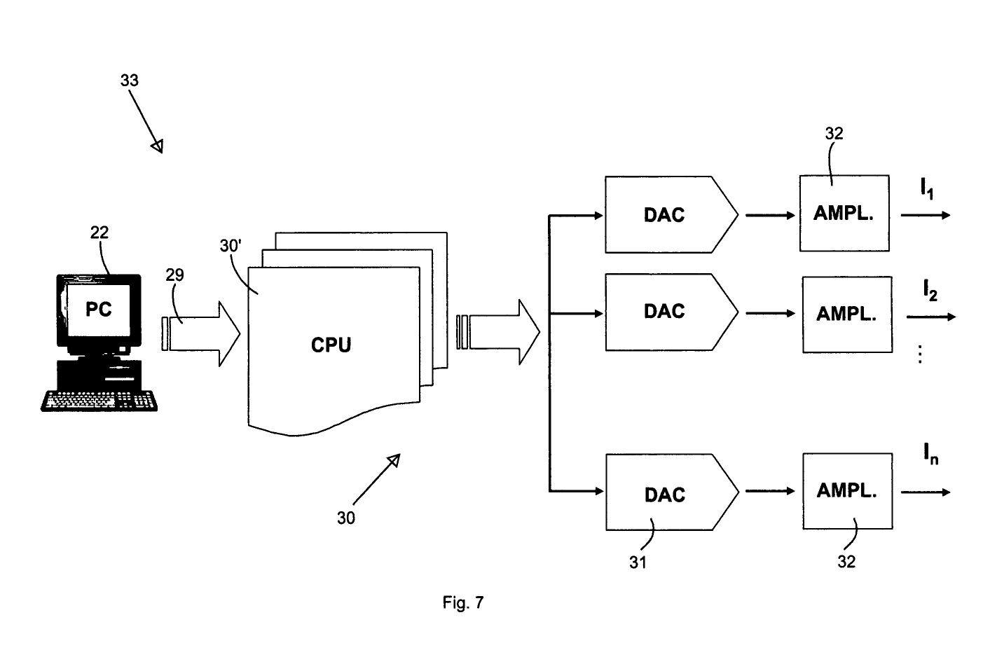

FIG. 7 diagrammatically shows control means of the device shown in FIG. 1,

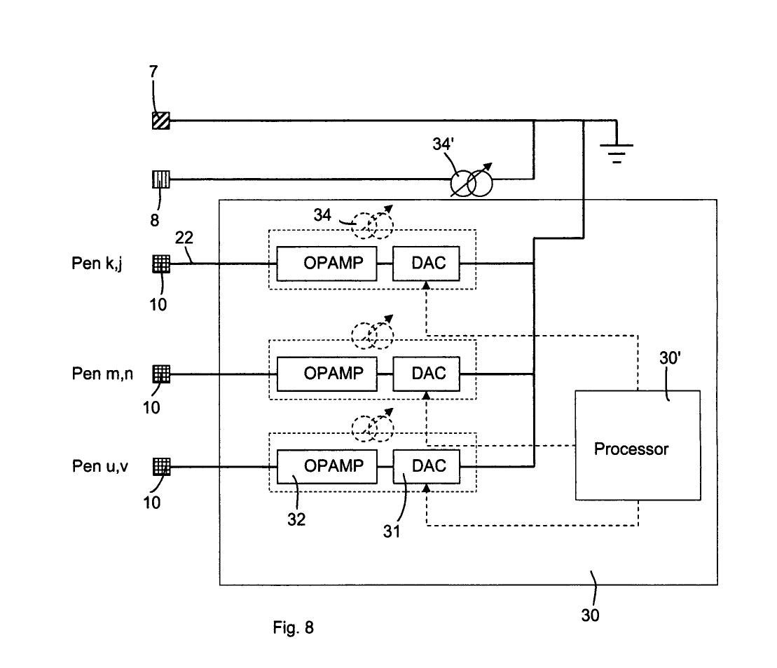

FIG. 8 diagrammatically shows a circuit diagram of the control means shown in FIG. 7,

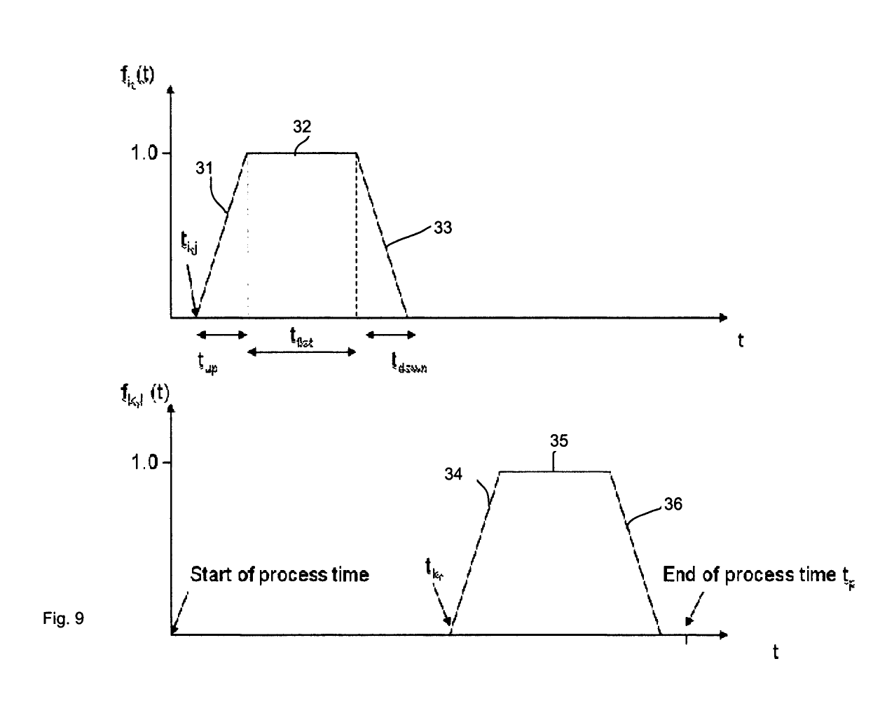

FIG. 9 contains two graphs of the control of an electrode close to the contact means and an electrode located away from the contact means, respectively,

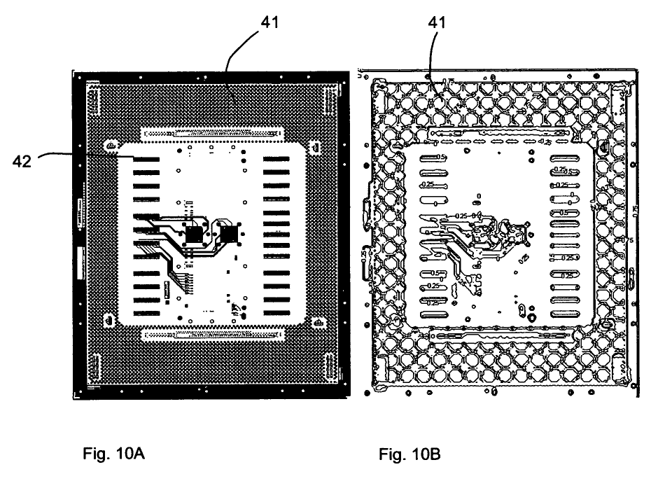

FIGS. 10A and 10B represent a front elevation of a substrate to be processed and a diagrammatic model viewed from the substrate of FIG. 10A, respectively,

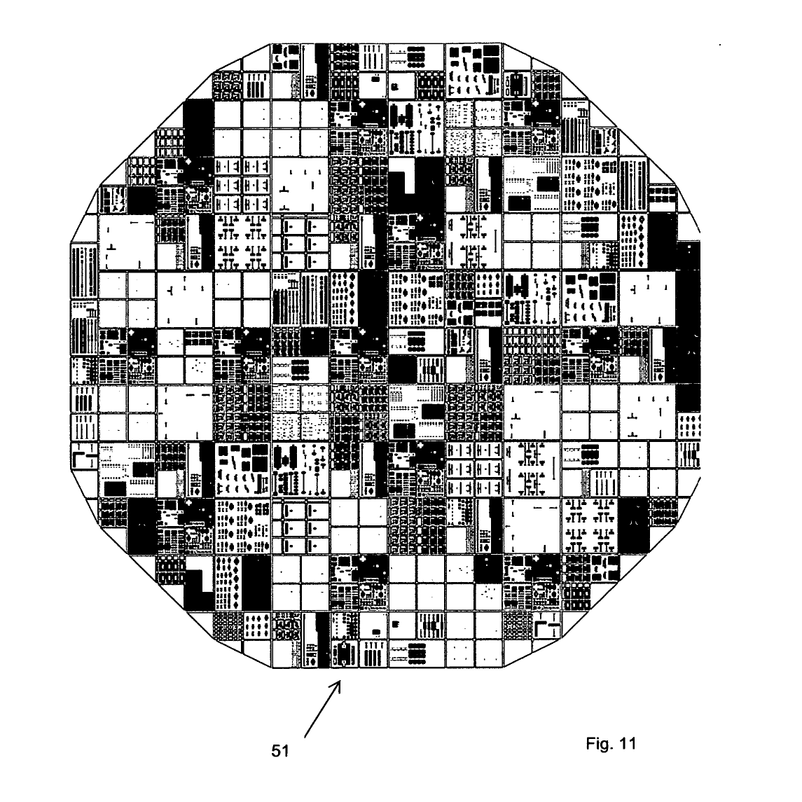

FIG. 11 is a front elevation of a wafer to be processed,

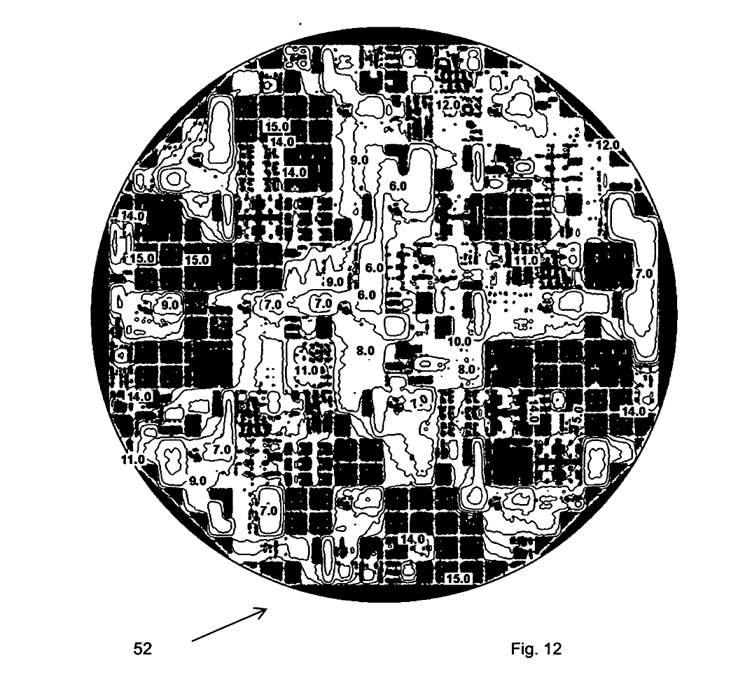

FIG. 12 is a front elevation with lines of equal layer thickness across a wafer, which wafer was treated by means of a device according to the prior art,

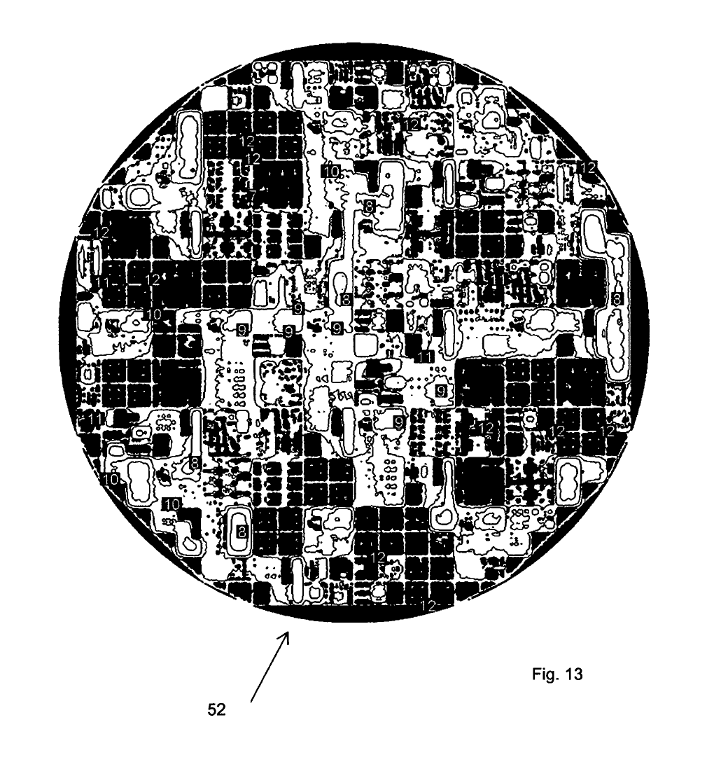

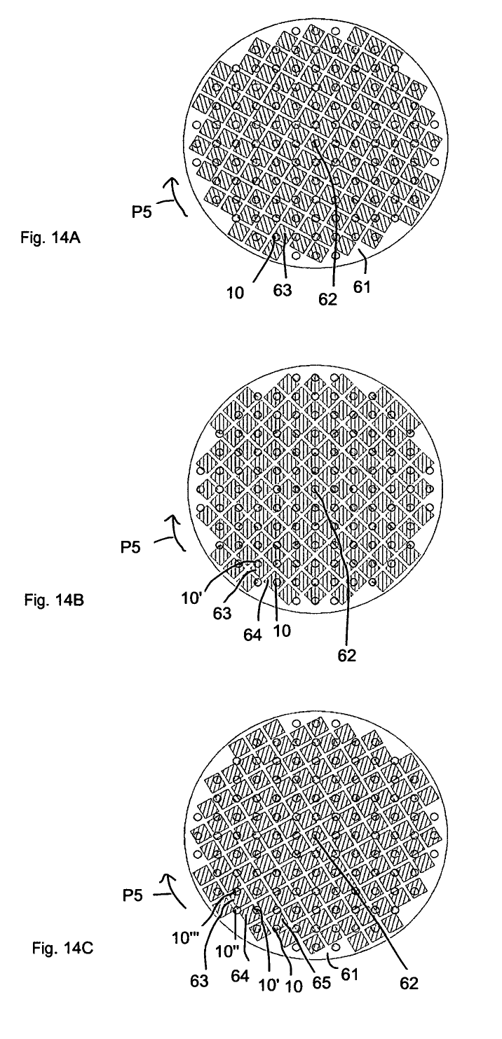

FIG. 13 is a front elevation with lines of equal layer thickness over a wafer, which wafer was treated by means of a device according to the invention,

FIGS. 14A to 14C are front elevations of a wafer during rotation thereof relative to the electrodes,

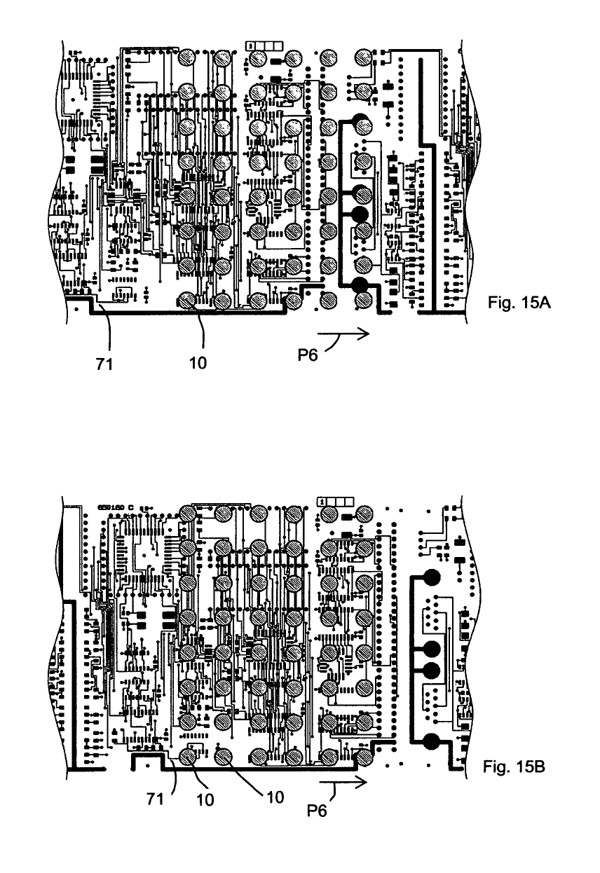

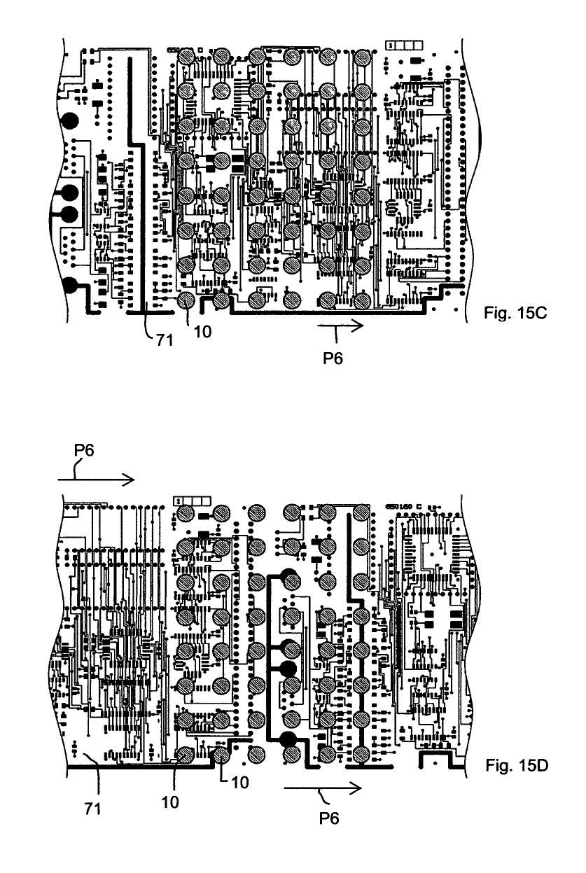

FIGS. 15A to 15D are front elevations of a wafer during translation thereof relative to the electrodes,

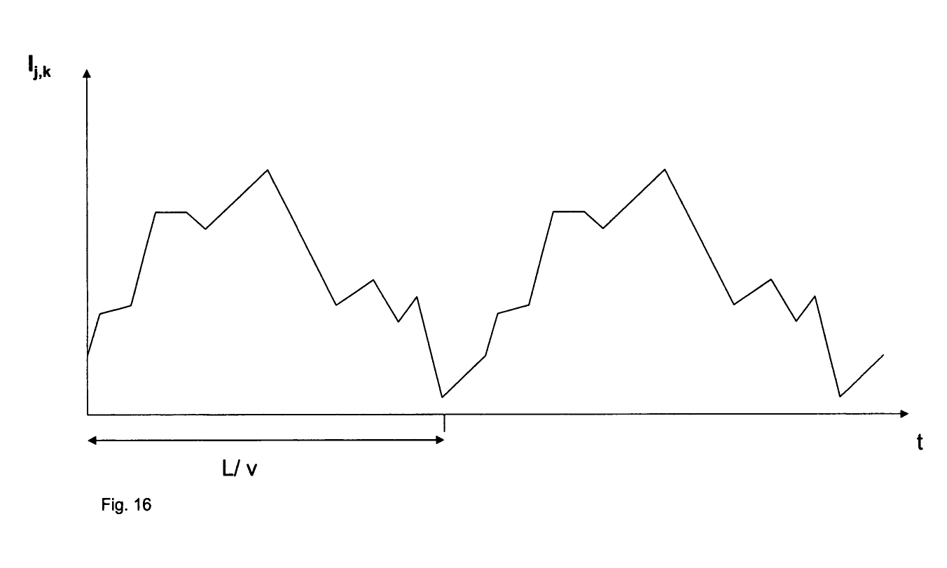

FIG. 16 is a graph representing the current flowing through a rod-shaped electrode during a certain period of time,

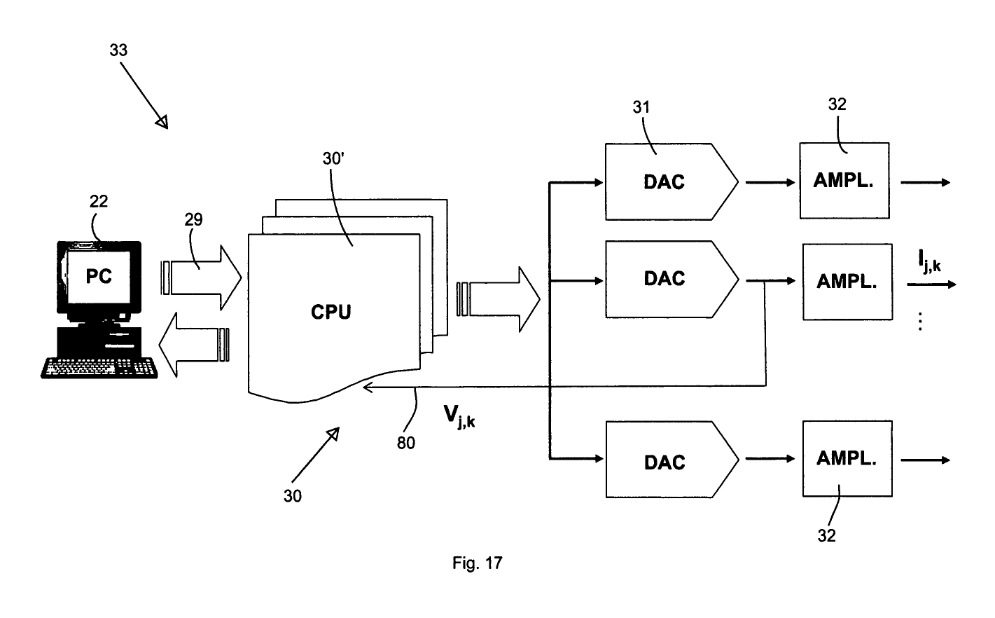

FIG. 17 diagrammatically shows the control means of FIG. 7 with feedback means added thereto,

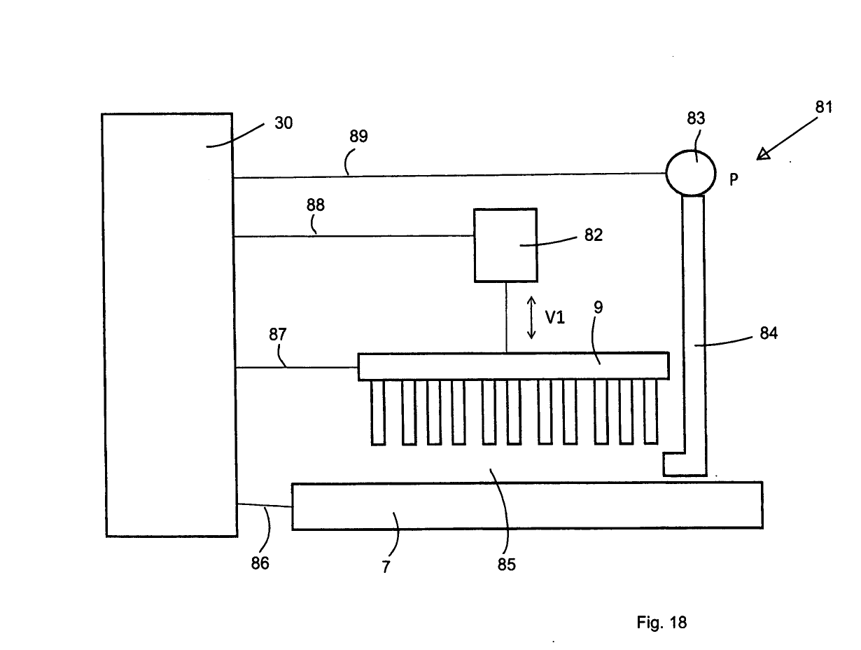

FIG. 18 diagrammatically shows a device according to the invention wherein electrodes are vibrated relative to the workpiece to be processed, and

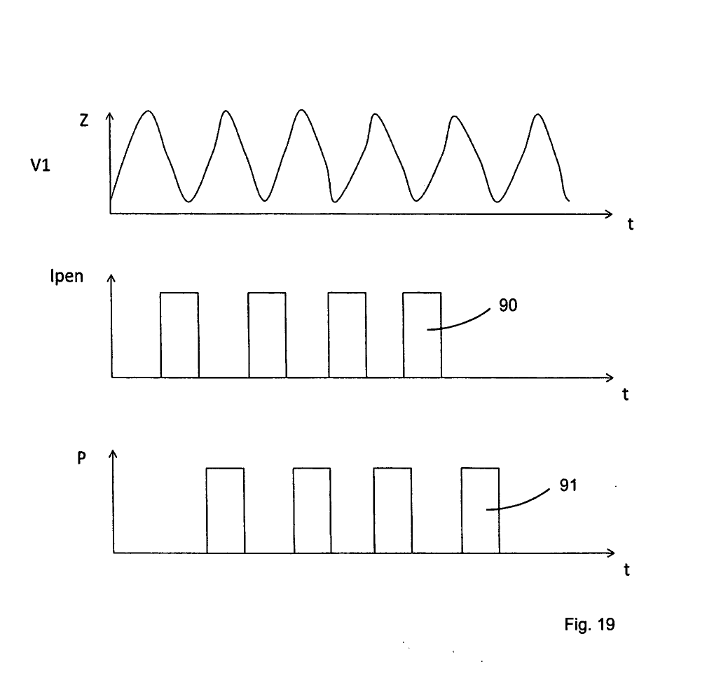

FIG. 19 shows graphs of the pulse speed, electric current, and electrolyte flow as a function of time.

FIG. 1 is a perspective view of a device 1 according to the invention, which is provided with a rectangular container 2 which is open towards an upper side, which container 2 delimits a chamber 3. A partition wall 4 is located in the chamber 3 and extends up to a predetermined distance from the upper side of the container 2. The container 2 is provided with an electrolyte inlet opening 5 and an electrolyte outlet opening 6 situated at the other side of the partition wall 4. Electrolyte can be introduced into the chamber 3 through the electrolyte inlet to opening 5 in a direction indicated by arrow P1, said electrolyte being guided over the partition wall 4 to the electrolyte outlet opening 6 and being discharged in a direction indicated by arrow P2.

Further present in the chamber 3 are a holder 7 for an object to be processed, a main electrode 8, and a holder 9 located between the holder 7 and the main electrode 8 and comprising rod-shaped electrodes 10.

FIG. 2 is an exploded perspective view of the device 1, in which in particular the construction of the holders 7, 9 is shown more clearly. The holder 7 is supported in a frame 10 with sliding possibility in a direction indicated by arrow P3, frame 10 being connected to a frame 11 in which the holder 9 is supported with sliding possibility in a direction indicated by arrow P4. The frames 10 and 11 are interconnected and the frame 11 is provided with a cover plate 12 at its side facing away from the frame 10. The holder 9 is provided with a frame 13, a cover plate 14, and a printed circuit board 15 located between the frame 13 and the cover plate 14 and fitted with rod-shaped electrodes to that extend transversely to said board 15. The holder 7 shown here is suitable for processing circular wafers (cf. FIGS. 11 to 14C), the rod-shaped electrodes 10 being arranged along concentric tracks or in an x,y raster. A number of electrodes 10 are arranged at a distance from one another in each track. The diameter of the circumferential circle corresponds substantially to the diameter of the wafer to be processed. As will be explained in more detail below, the holder 9 shown in FIG. 2 with the printed circuit board 15 is suitable for processing wafers with various patterns and/or seed layers provided thereon.

A different printed circuit board 15 is to be used for processing a rectangular object, in which case the rod-shaped electrodes are arranged in an x,y raster that is enclosed by a rectangle.

FIGS. 3A to 3C show different views of the printed circuit board 15, which is built up from three layers 16, 16″, 16′″ provided with respective printed circuits. Each layer has passages 17 for electrolyte which extend transversely through the layers 16′, 16″, 16′″ and openings 18 located in between the passages 17, in which openings 18 ends 19 of the rod-shaped electrodes 10 are fastened. Each layer 16′, 16″, 16′″ comprises electrically conductive tracks (see FIG. 3C) which each lead to one of the openings 18 and form an electrically conductive ring 20′ in and around the respective opening 18. The openings 18, located above one another, of the different layers 16′, 16″, 16′″ are interconnected by an electrically conductive cylindrical surface 20″ (see FIGS. 5, 6). Each layer 16′, 16″, 16′″ comprises electrically conductive tracks 20 to a different group of openings is. Since the printed circuit board 15 is built up from a number of layers 16′, 16″, 16′″, the tracks 20 can have a comparatively great width whereby a good electrical conductance is realized. All tracks 20 of a layer 16′, 16′, 16′″ are connected to a plug 21 which is connected via a cable comprising a plurality of wires to a control unit 30 (see FIG. 7).

FIG. 4 is a cross-sectional view of the device 1 shown in FIG. 1 in which the holder 7, the wafer 23 supported thereby, and the oppositely located rod-shaped electrodes 10 are clearly visible.

FIGS. 5A and 5B are detailed cross-sectional views of the printed circuit board 15, wherein a rod-shaped electrode 10, for example manufactured from a chemically inert material such as tantalum, titanium, or stainless steel, is provided with a copper layer 25 by means of electrochemical deposition up to a predetermined distance from the tip. The rod-shaped electrodes 10 have a diameter of, for example, 1 mm. The copper layer 25 has a thickness of, for example, 50 microns. The copper-plated end of the rod-shaped electrode 10 is connected by means of a welded joint 26 to the electrically conductive cylindrical surface 20″ at a side of the layer 16′ facing away from the layer 16′″.

Each rod-shaped electrode 10 is in electrical contact with a ring 20′ of a track 20 in one of the layers 16′, 16″, 16′″ via the copper layer 25.

For electrical insulation of the printed circuit board 15 and the rod-shaped electrodes 10 and to protect them from chemical attacks by the electrolyte, the printed circuit board 15 and the rod-shaped electrodes 10 extending transversely thereto are provided with an insulating and protective resin or plastic layer 27 up to said predetermined distance from the tip. The exposed tip of each rod-shaped electrode 10 is electrochemically activated by means of a thin covering layer of, for example, platinum or iridium oxide.

An alternative embodiment of the printed circuit board 15 is shown in FIGS. 6A and 6B, where only the portion of the rod-shaped electrode located inside the printed circuit board 15 is provided with a copper layer 28. This copper layer 28 may be provided, for example, in that a copper bush is pressed over the rod-shaped electrode. The copper layer 25, 28 renders it possible to realize a good welded joint 26 with the layer 16′″ in a simple manner.

FIG. 7 shows the control means 33 of the device 1 according to the invention, which control means 33 are provided with a computer 22 which is situated at a distance from the container 2 and which drives a control unit 30, for example via an USB connection 29. Said control unit 30 comprises a CPU 30′, various digital to analog converters 31, and amplifiers 32. Current signals from the digital to analog converters 31 are guided via the amplifiers 32 to the various electrically conductive tracks 20 of the printed circuit board 15. Each digital to analog converter 31 together with the associated amplifier 32 forms an individual current source 34 for a rod-shaped electrode 10. Each rod-shaped electrode 10 is provided with the desired current via the tracks 20. The digital to analog converter 31 and the amplifiers 32 are preferably located on a common support such as, for example, a printed circuit board. The support is then electrically coupled to the tracks 20 of the printed circuit board 15 by means of a cable.

Each digital to analog converter 31 can be addressed for updating the current to be provided by means of the CPU 30′ on the basis of a unique identity code of the respective digital to analog converter 31 or on the basis of an X, Y multiplexing system. If the CPU 30′ is capable of updating the current value for each digital to analog converter 31 at a speed of, for example, 1 MB per second, it will be possible not only to provide direct currents or currents varying linearly with time, but also to generate unipolar or bipolar pulsatory currents. If a higher speed is required, it is possible to control a number of CPUs 30′ in parallel by means of a central controller. Given a speed of at least 1 MB per second, it is possible to provide a complete holder comprising a few hundred rod-shaped electrodes 10 with any instantaneously required current within a time frame of less than 1 ms. This implies that also the unipolar or bipolar pulsatory currents with a frequency in the ms range can be applied to the rod-shaped electrodes 10.

FIG. 8 shows the circuit diagram, from which it is apparent that the holder 7 and the wafer supported thereby are directly connected to ground. The rod-shaped electrodes 10 are in fact each provided with a controllable current source 34 by the control means 33 shown in FIG. 7. If the main electrode (anode) 8 is activated, this is done by means of a separate current source 34′, which is either separate from the control unit 30 or is integral with the control unit 30. The main electrode 8 is made from copper and acts as the anode. The wafer acts as the cathode, copper from the main electrode 8 being dissolved in the electrolyte during the electrochemical process, thus supplementing and compensating for the quantity of copper from the electrolyte that is deposited on the wafer. The value of the current I passed through each rod-shaped electrode 10 is determined on the basis of the layer to be deposited on the object, the thickness or thickness distribution of the layer already present on the object prior to the electrochemical deposition process, and the distribution of the so-termed active surface fraction (resulting from the presence of a lithographic pattern) over the object.

During the coating of a wafer, a comparatively thin, so-termed seed layer of, for example, 0.1 micron copper or nickel is present already in those locations where an additional copper layer is to be provided. It is also possible for a seed layer of no more than 0.001 micron, for example of tantalum, to be present.

This comparatively thin seed layer conducts current comparatively badly. The result is that material can be readily deposited in particular at the edges of the wafer, where current needs to be conducted over only a comparatively short distance to the electrically well conducting contact points or contacting ring of the holder 7, whereas this takes place comparatively poorly at a distance to the edges of the wafer.

The device 1 according to the invention renders it possible to provide the rod-shaped electrodes 10 located opposite the edges of the wafer with current first and to provide the rod-shaped electrodes 10 located more centrally with respect to the wafer with current at a later moment during the electrochemical processing of the wafer.

Such a method is illustrated, for example, in FIG. 9, where a rod-shaped electrode 10 located adjacent the edge of the wafer is gradually brought to a desired maximum current level 32 in accordance with a linear function 31 over a time period tᵤₚ of, for example, a few seconds and subsequently, after a predetermined time period t_{flat}, of, for example, a few minutes, is divested of current again in accordance with a linear function 33 over a time period t_{down} of, for example, a few seconds. The total surface area present below the graph 31, 32, 33 multiplied by the amplitude of the current determines the total amount of electric charge passing through the rod-shaped electrode to and accordingly determines the quantity of copper deposited on the wafer opposite this rod-shaped electrode 10.

As the lowermost graph in FIG. 9 shows, a rod-shaped electrode 10 located at a distance from the edge of the wafer will be provided with current in accordance with a linear function 34 after a comparatively long period of time, is subsequently provided with the constant maximum current 35 during a predetermined period, whereupon the current to the rod-shaped electrode to is gradually stepped down again in accordance with a linear function 36. It is possible for the linear functions 31, 34 to be identical to the functions 33, 36, respectively. Alternatively, however, it is possible to vary these functions for each rod-shaped electrode 10. The time period t_{flat} during which the maximum current is passed through the rod-shaped electrode 10 may be different for each rod-shaped electrode 10 and depends mainly on the total quantity of copper that is to be provided on the wafer opposite the relevant rod-shaped electrode 10. It is possible in practice first to determine the desired current amplitude I_{i,j} for each electrode 10, for example on the basis of the active surface fraction distribution over the object. Then it is determined from what moment onward this current is to be applied in that the time function f_{i,j}(t) is defined. The time-dependent current profile through the rod-shaped electrode 10 is then given by I_{i,j} multiplied by f_{i,j}(t).

The specific moments and the current occurring during these are dependent on inter alia the thickness and nature of the seed layer, the distribution of the seed layer over the surface of the wafer, the manner in which the wafer is contacted and in particular the positions and dimensions of the contact means where the wafer is in electrical contact with the holder 7, the degree of uniformity of the layer that is to be provided on the wafer, the maximum admissible processing time, etc.

The sequence in which the rod-shaped electrodes to are provided with current may be the following, for example:
first the rod-shaped electrodes to are defined that lie closest to the contact points of the holder 7. These rod-shaped electrodes 10 are provided with current first and are regarded as first-generation pins,
then the rod-shaped electrodes to are defined that lie within a distance Δx from the first-generation pins but are no first-generation pins themselves. These rod-shaped electrodes to are regarded as second-generation pins and are provided with current starting from a certain moment after the first-generation pins were provided with current,
subsequently the rod-shaped electrodes 10 are defined that lie within a distance Δx from the second-generation pins but are no second-generation pins themselves. These rod-shaped electrodes 10 are regarded as third-generation pins and are provided with current starting from a certain moment after the second-generation pins were provided with current,
this is continued until all rod-shaped electrodes 10 have been included in a certain generation of pins.

The times tᵤₚ and t_{down} may be optimized for taking into account the internal resistance values of the wafer while it is ensured that the maximum voltage necessary for realizing the desired current is lower than the maximum admissible voltage. The following problems may occur when too much voltage is lost in the seed layer on the wafer:
the current supplied by the rod-shaped electrodes to located far from the contact points will flow to regions closer to the contact points owing to the electrolyte, so that more copper than is desirable will be deposited in these regions of the wafer,
heat will be generated in the wafer causing the temperature to rise, which may damage the wafer and impair the quality of the deposited layer. The electrolyte may also become too warm as a result of this.

The current required for each rod-shaped electrode 10 may be based on, for example, the construction of the surface of the wafer situated opposite the relevant rod-shaped electrode 10. If this surface comprises a comparatively large area that is exposed to the electrolyte (i.e. is not covered by photo resist), said surface has a comparatively large active surface fraction. As the active surface fraction located opposite a certain rod-shaped electrode 10 is larger, a stronger current is to be passed through the relevant rod-shaped electrode to as against the case of a comparatively small active surface fraction lying opposite a certain rod-shaped electrode 10.

Computer models or experiments may be used for determining the current to be passed through each rod-shaped electrode 10, the start and end moments of the current through the rod-shaped electrode 10, etc.

A first strategy for determining the current to be passed through the rod-shaped electrode 10 is based on the active surface fraction of a raster element located opposite the tip of a given rod-shaped electrode 10 on the workpiece to be processed, which is provided with a pattern. A workpiece to be processed in subdivided into a two-dimensional raster having a resolution in two main directions which corresponds to the spaces between the pins in these directions. The pins are arranged, for example, in an XY pattern. The active surface fraction ε_{i,j} is subsequently determined for each raster element. The active surface fraction is that portion of the raster element that is to be provided with a layer. Each rod-shaped electrode to having a position i,j is assigned a current that is proportional to the active surface fraction ε_{i,j} in the raster element that is located immediately opposite the relevant rod-shaped electrode 10.

If the total current to be applied is Iₜₒₜ, for a total series of regularly spaced rod-shaped electrodes N×M, then the current to be delivered to each rod-shaped electrode (I,j) is defined as:

$${I}_{ij} ( t ) = \frac{{ɛ}_{ij} f ( t ) {I}_{tot} {A}_{tot}}{NMA}$$

Herein, f_{i,j}(t) is the time function of FIG. 9, Aₜₒₜ is the total geometric surface area of the object, and A is the total electro-active surface area of the object.

An exact approximation will be that I_{i,j}(t) is determined not only on the basis of the active surface fraction of the raster element located opposite the rod-shaped electrode (i,j), but that also a weighted contribution of the surrounding raster elements is included.

Another strategy requires a computer simulation based on a physical electrochemical model that takes into account at least:
the geometric dimensions and positions of a patterned workpiece,
the geometric dimensions and positions of the rod-shaped electrodes in the holder,
the geometric dimensions and positions of the main electrode, if present,
the ohmic drop in the electrolytic solution,
the polarization behaviour of the etching or deposition process,
the polarization behaviour of the rod-shaped electrode (anodic or cathodic).
   The Laplace model is described by the equations below:

Electrolyte domain ΔU=0

Electrodes j=g(V−U)

Insulating surfaces j=0.0

Electrolyte surface j=0.0

where U is the local electrolyte potential and V is the electrode potential. The current density j is directly proportional to the component of the local vector gradient of the potential U that is perpendicular to the relevant surface. The function g describes the electrochemical reactions that take place on the electrodes.

Another strategy for determining the current through the individual rod-shaped electrode to comprises a comparatively random choice of the current through each rod-shaped electrode 10 and a subsequent processing of the workpiece while these currents I_{i,j}(t) are being applied, wherein the current may be gradually increased and also gradually reduced again. Then the layer thickness experimentally obtained is measured across the workpiece, using raster elements having the same resolution as the pattern of the rod-shaped electrodes. In a subsequent operation, the rod-shaped electrodes that correspond to raster elements at which the layer thickness is below the desired layer thickness are given more current than the original current passed through the relevant rod-shaped electrodes, whereas less current will be applied to those rod-shaped electrodes where the layer on the associated raster elements is too thick. In a first approximation, the difference between the original and the new current value may be taken linearly proportional to the local difference between the desired and the actual layer thickness. Then a fresh workpiece is processed to which the new currents I_{i,j}(t) are applied. These experiments and adaptations of the currents are repeated until the entire layer thickness distribution over the patterned workpiece lies within the relevant specifications.

It is obviously also possible to combine the above strategies such that, for example, desired current profiles are first determined from a computer model, then a workpiece is processed with the currents thus determined, and currents and current patterns are subsequently adapted and the computer models are optimized, if so desired.

It will be clear that the results of a workpiece that is to be processed with a certain holder is dependent on the distance Δx, Δy between mutually adjoining rod-shaped electrodes and on properties of the rod-shaped electrodes such as the diameter D, the exposed length SL, and the distance DS to the workpiece to be processed. Depending on the degree of uniformity of the layer thickness to be applied on the workpiece that is required, a different holder with a different configuration of rod-shaped electrodes may be used so as to comply with this requirement. A first starting point here may be, for example, the initial values of Δx, Δy, D, SL, and DS, whereupon the currents to be passed through the individual rod-shaped electrodes may be determined by means of computer models. The layer thickness distribution obtained from the computer model calculations is then compared with the desired layer thickness.

If the computer model results show that the layer thickness can be sufficiently closely approached through adaptation of the current through individual rod-shaped electrodes, this will be tested by means of a practical processing of an object wherein these currents are passed through the respective rod-shaped electrodes. Should it appear after the evaluation of the layer thickness obtained on the basis of the computer model or on the basis of the practical test that the desired layer thickness distribution is insufficiently achieved, a holder with smaller values for Δx, Δy and adapted values of D, SL, or DS may be used.

It is furthermore possible to have certain rod-shaped electrodes function as so-termed current robbers or coelectrodes in a manner comparable to that described in the present applicant's international patent application WO 2008/010090 A2, such that part of the current directed at the wafer is drained off via the coelectrode. This renders it possible to manage the current density distribution across the wafer more accurately. The coelectrode here has the same polarity as the holder 7 and the wafer supported thereby.

FIGS. 10A and 10B show a rectangular substrate 41, FIG. 10A showing the substrate 41 with a lithographically deposited photo resist layer (white) and the active electrode surface (black) prior to the deposition of a layer thereon. The substrate 41 is provided with a metal seed layer 42. FIG. 10B shows the distribution of the active surface fractions ε_{i,j} over the substrate 41. This active surface fraction distribution forms the basis on which the current to be conducted by each rod-shaped electrode 10 is determined in accordance with one of the strategies set out above.

FIG. 11 shows a wafer 51 with a lithographically deposited photo resist layer (white) and the active electrode surface (black).

FIG. 12 shows a wafer 52 on which copper has been deposited by means of a device according to the prior art. The numbers indicate the thicknesses of the respective copper layers. It is noteworthy that the thickness varies between 6 and 15 microns.

FIG. 13 shows the layer thickness distribution over a wafer processed by means of the device 1 according to the invention. The layer thickness here varies between 8 and 12 microns. A further enhancement of the uniformity of the layer thickness may be realized, for example, in that the current density distribution during processing of the wafer is further optimized, thinner rod-shaped electrodes are used which lie closer together, etc.

FIGS. 14A to 14C show a pattern of stationary rod-shaped electrodes 10 which are located opposite a wafer 61, which wafer 61 can rotate in a direction indicated by arrow P5 about an axis that extends coaxially with a centrally located rod-shaped electrode 62.

The wafer 61 is rotated, for example, by an electric drive (not shown) that is connected to the holder 7. The rotation of the wafer achieves a better renewal of the electrolyte between the rod-shaped electrodes 10 and the wafer 61.

As is clearly visible in FIG. 14A, the rod-shaped electrode referenced 10 is located opposite a segment 63 of the wafer 61, which segment 63 is located opposite a rod-shaped electrode referenced 10′ in the position of the wafer 61 in FIG. 14B, where it has been rotated through 15 degrees. The rod-shaped electrode 10 is now located opposite a segment 64 of the wafer 61 which is situated next to the segment 63.

A further rotation of the wafer through 15 degrees in the direction indicated by the arrow P5 causes a segment 65 to be positioned opposite the rod-shaped electrodes 10 (FIG. 14C). The segments 63, 64 are situated opposite the rod-shaped electrodes referenced to 10′″, 10″ and 10″, 10′, respectively.

The current conducted through the rod-shaped electrodes should be such that the current distribution over the surface of the wafer is substantially the same as in the situation wherein the wafer 61 is occupying a stationary position to relative to the rod-shaped electrodes.

FIGS. 15A to 15D shows an alternative embodiment of a device according to the invention wherein a rectangular raster of rod-shaped electrodes 10 is located opposite a portion of an elongate substrate 71 (for example a flexible printed circuit board) with a lithographically deposited photo resist layer (white) and an active electrode surface (black). The substrate 71 is displaced stepwise or continuously in a direction indicated by arrow P6 relative to the rod-shaped electrodes 10. A current is passed through each rod-shaped electrode 10 that is dependent on the portion of the printed circuit board 71 present opposite the relevant rod-shaped electrode 10 at any given moment and on the layer thickness that is to be realized on the relevant portion of the substrate 71.

The printed circuit board is, for example, 600 mm wide and 1000 mm long. For an accurate processing of such a printed circuit board, the electrodes 10 may be arranged in a raster with a pitch of 20 mm, for which approximately 1500 electrodes are required.

FIG. 16 is a graph in which the time is plotted on the horizontal axis and the current I_{j,k} through a rod-shaped electrode 10 in position j,k on the vertical axis. Since the substrate 71 is displaced in the direction indicated by arrow P6, a different portion of the substrate 71 is present opposite the relevant rod-shaped electrode to each time. The control means 33 ensure that the desired current I_{j,k} is applied to the relevant rod-shaped electrode 10 in position j,k at any given moment. Given a length L of a repetitive lithographic pattern on the substrate 71 and a speed V of the substrate 71 in the direction of the arrow P6, the current pattern will be repeated at a rate of L/V.

It is possible during the electrochemical processing of an object to cause the rod-shaped electrodes and the object to vibrate relative to one another in a direction transverse to the object, whereby a good flow and renewal of the electrolyte is achieved. It is possible in this case to reduce the current or switch it to zero temporarily during part of the vibration period.

Depending on the object to be processed, some of the rod-shaped electrodes will not be provided with current. To prevent these rod-shaped electrodes from starting to act as cathodes during the electrochemical deposition process, it is possible to cause a comparatively weak anodic current to flow through these rod-shaped electrodes, which are not necessary for the treatment of the object, so that the deposition of a layer on these rod-shaped electrodes is prevented in a simple manner. The comparatively weak current will not have any substantial influence on the electrochemical processing of the object.

The application of a layer by means of the device according to the invention may also relate to through passages and blind holes present in an object, in which case the current through the oppositely located rod-shaped electrode is such that the layer thickness in the through passages or blind holes is an optimum.

Given a wafer with a diameter of 20 to 30 cm and rod-shaped electrodes spaced 4 to 6 mm apart, the holder will comprise 500 to 1000 rod-shaped electrodes 10. It can be checked whether all electrodes still function by positioning a reference object opposite the rod-shaped electrodes, then applying a current to each electrode consecutively, and measuring the resulting voltage between the reference object and the rod-shaped electrode. If this differs too much from a desired value, this is a signal that the relevant electrode does not function correctly. The relevant electrode will have to be repaired or replaced.

This check or test may be carried out fully automatically by means of the same control unit 30 that is also used for the normal control of the rod-shaped electrodes 10. FIG. 17 shows control means 33 which largely correspond to the control means shown in FIG. 7. A CPU 30′ controls a digital to analog converter 31 which in its turn sends a current I_{j,k} via the amplifier 32 to a rod-shaped electrode 10 located in a position j,k in a raster pattern. Herein j denotes the X-position and k the Y-position, for example. The voltage value V_{j,k} necessary for achieving the current I_{j,k} is detected via a connection 80 and passed on to the CPU 30′. The CPU 30′ transmits the data to the PC 22, where they are compared with the reference values.

The reference object used may be a plate-shaped electrode, but alternatively a group of adjoining rod-shaped electrodes may be regarded as a reference object. In the latter case these rod-shaped electrodes will be oppositely polarized with respect to the rod-shaped electrodes under test.

An alternative method is to apply a potential difference between the reference object and a rod-shaped electrode and to measure the current flowing through it. If the absolute value of the current amplitude is below a certain value, the relevant rod-shaped electrode should be repaired or replaced.

If an rod-shaped electrode is to be operated as a coelectrode, a layer may be deposited on this rod-shaped electrode. To remove this layer, a cleaning electrode may be positioned opposite the rod-shaped electrodes such that all rod-shaped electrodes are operated as anodes. The deposited metal will subsequently be dissolved in the electrolyte.

FIG. 18 diagrammatically shows a device 81 according to the invention which is provided with a holder 7 for a workpiece to be processed and a holder 9 located opposite the holder 7. The holder 9 supports a few hundred rod-shaped electrodes 10 which extend transversely to the main surface of the holder 9. The holder 9 is connected to a motor 82 that is capable of moving the holder 9 to and fro with a speed V1 in a direction transverse to the main surface of the holder 9. The device 81 is further provided with a pump 83 by means of which electrolyte is pumped via a line 84 into a space present between the holders 7 and 9. The holders 7, 9 and the line 84 are located in a container (not shown) that is filled with electrolyte.

The holders 7, 9, the motor 82, and the pump 83 are connected to the control unit 30 via respective connection lines 86, 87, 88, and 89.

The holder 9 is displaced by the motor 82 with a speed V1 in the Z-direction transverse to the holder 9 during the electrochemical processing of the workpiece supported by the holder 7.

FIG. 19 shows the speed V1 in the Z-direction plotted as a function of time. The rod-shaped electrodes 10 are provided with current in dependence on the position of the holder 9 relative to the holder 7, which position may be ascertained, for example, by means of a sensor coupled to the motor 82. The current Iₚₑₙ is applied to a rod-shaped electrode 10 only if the distance between the rod-shaped electrodes to and the holder 7 is comparatively small. The current is reduced to zero the moment the distance increases. This is represented by the square wave current pulses 90. If the distance between the rod-shaped electrodes 10 and the holder 7 is comparatively small, it is practically impossible for electrolyte to flow through the space 85, which is comparatively narrow at that moment. The moment the holder 9 is at a greater distance to the holder 7, the space 85 will be correspondingly larger. That is the moment the pump 83 is activated, and electrolyte will be pumped via the line 84 through the space 85. This is depicted in the lowermost graph of FIG. 19, where the activation of the pump P is plotted as a function of time. The pump 83 is also activated by square wave pulses 91, which pulses 91 are located in time between the square wave pulses 90.

Instead of rod-shaped electrodes, it is possible to construct the electrodes as projections extending from a holder and having a height of too microns to a few mm. It is also possible to integrate the electrodes in the surface of the holder. The electrodes will again be arranged in a raster pattern here, however, so that each portion of the object's surface to be treated lying opposite an electrode can be provided with a current profile desired for that portion. The raster pattern may be a pattern in which the spaces between the electrodes are the same in the x- and the y-direction. Alternatively, however, the electrodes may be arranged in a number of concentric annular tracks, the electrode pitch being constant within each given track. The electrodes may also be arranged in a diamond pattern or any other repetitive pattern.

In proportion as there is less space available between the electrodes and the workpiece under treatment and among the electrodes themselves, the renewal of the electrolyte present in this space will become more difficult and it will be necessary, for example, to vibrate the holder relative to the object or to displace it relative to the object over a comparatively large distance at regular intervals. It is possible in this case to reduce or completely cut off the current temporarily during the vibration. This results in square wave pulsed currents with a frequency equal to the frequency of the vibratory movement.

The current sources for the electrodes may be present on the same holder as the rod-shaped electrodes, or on a holder situated at a distance therefrom.

The electric current through the electrodes may also be determined on the basis of the thickness or thickness distribution of the layer already present on the object prior to the electrochemical process.

1-25. (canceled)

26. A device suitable for the electrochemical processing of an object, which device is at least provided with a chamber that is to accommodate an electrolyte, means for supporting the object that is to be processed in said chamber, electrodes located in said chamber and arranged in an iterative raster pattern such that during operation at least one electrode is located opposite each portion of a surface of said object that is to be processed, as well as control means for providing an electric current between the object that is to be processed and the electrodes, characterised in that the device is provided with a separate current source for each electrode or group of electrodes to supply during the electrochemical processing operation by the control means the electric currents originating from the separate current sources to at least a number of electrodes or a number of groups of electrodes separately and in accordance with predetermined different current profiles in time during the electrochemical processing of the object to realize a predetermined desired current density distribution across the object.

27. A device according to claim 26, characterised in that the object and the electrodes are displaceable relative to one another, while during the electrochemical processing operation by the control means the electrodes are provided with a current profile in dependence on the positions of the electrodes relative to the object.

28. A device according to claim 26, characterised in that the device is provided with contact means for electrically contacting the object, while during the electrochemical processing operation by the control means electrodes located at a distance from the contact means are provided with a current profile different from that of electrodes located closer to contact means.

29. A device according to claim 28, characterised in that the object and the electrodes are displaceable relative to one another, while during the electrochemical processing operation by the control means the electrodes are provided with a current profile in dependence on the positions of the electrodes relative to the object.

30. A device according to claim 26, characterised in that the electrodes are arranged in said iterative raster pattern in a holder comprising at least a printed circuit board for controlling the individual electrodes.

31. A device according to claim 30, characterised in that passages for the electrolyte are situated between the electrodes and the holder.

32. A device according to claim 26, characterised in that the device is provided with checking means for applying in use a potential difference between each electrode in turn and a reference object, for measuring in use the current arising therefrom and for comparing in use the measured current can be compared with an expected current by the checking means, while in the case that the difference between the measured current and the expected current is larger than a predetermined value, the relevant electrode need to be replaced or repaired.

33. A device according to claim 26, characterised in that the device is provided with contact means for electrically contacting the object, while during the electrochemical processing operation by the control means electrodes located at a distance from the contact means are provided with a current profile different from that of electrodes located closer to contact means and that the device is provided with checking means for applying in use a potential difference between each electrode in turn and a reference object, for measuring in use the current arising therefrom and for comparing in use the measured current can be compared with an expected current by the checking means, while in the case that the difference between the measured current and the expected current is larger than a predetermined value, the relevant electrode need to be replaced or repaired.

34. A device according to claim 26, characterised in that the electrodes can be vibrated relative to the object in a direction that is transverse to the object.

35. A device according to claim 26, characterised in that that the device is provided with contact means for electrically contacting the object, while during the electrochemical processing operation by the control means electrodes located at a distance from the contact means are provided with a current profile different from that of electrodes located closer to contact means and that the electrodes can be vibrated relative to the object in a direction that is transverse to the object.

36. A holder suitable for the electrochemical processing of an object, characterised in that electrodes are arranged in an iterative raster pattern in the holder, which holder comprises at least a printed circuit board provided with a separate current source for each electrode or group of electrodes.

37. A method suitable for the electrochemical processing of an object, whereby an object is introduced into a chamber containing an electrolyte and whereby an electric current is caused to flow between the object to be processed and electrodes by control means, which electrodes are located in said chamber and are arranged in an iterative raster pattern such that during operation at least one electrode is located opposite each portion of a surface of said object that is to be processed, characterised in that an individual current source is provided for each electrode or group of electrodes such that the electric currents originating from the separate current sources can be supplied by the control means to at least a number of electrodes or a number of groups of electrodes separately and in accordance with predetermined current profiles in time during the electrochemical processing of the object so as to realize a predetermined desired current density distribution across the object.

38. A method according to claim 37, characterised in that the electric current through each electrode is measured, and the measured value is compared with an expected value.

39. A method according to claim 37, characterised in that the electric current through the electrode is determined on the basis of the active surface fraction on the object adjacent to the electrode.

40. A method according to claim 37, characterised in that the electric current through each electrode is measured, and the measured value is compared with an expected value and the electric current through the electrode is determined on the basis of the active surface fraction on the object adjacent to the electrode.

41. A method according to claim 37, characterised in that different electrical potential differences are applied between individual electrodes and the object during the time of the electrochemical processing, wherein said electrical potential difference between an electrode and the object is varied.

42. A method according to claim 37, characterised in that the electric current through each electrode is measured, and the measured value is compared with an expected value and that different electrical potential differences are applied between individual electrodes and the object during the time of the electrochemical processing, wherein said electrical potential difference between an electrode and the object is varied.

43. A method according to claim 37, characterised in that the control means provide electrodes located at a distance from the contact means with a current profile different from that provided to electrodes located closer to contact means during the electrochemical processing operation.

44. A method according to claim 37, characterised in that the electric current through each electrode is measured, and the measured value is compared with an expected value and that the control means provide electrodes located at a distance from the contact means with a current profile different from that provided to electrodes located closer to contact means during the electrochemical processing operation.

45. A method according to claim 37, characterised in that a comparatively weak current is passed by the control means through those electrodes that are substantially not required for the electrochemical process.

46. A method according to claim 37, characterised in that the electric current through each electrode is measured, and the measured value is compared with an expected value and that a comparatively weak current is passed by the control means through those electrodes that are substantially not required for the electrochemical process.

47. A method according to claim 37, characterised in that a potential difference is applied between each electrode in turn and a reference object and the current arising therefrom is measured, which current is compared with an expected current by checking means, the relevant electrode being replaced or repaired in the case of a comparatively great difference.

48. A method according to claim 37, characterised in that the electric current through each electrode is measured, and the measured value is compared with an expected value and that a potential difference is applied between each electrode in turn and a reference object and the current arising therefrom is measured, which current is compared with an expected current by checking means, the relevant electrode being replaced or repaired in the case of a comparatively great difference.
